(19) United States
(12) Patent Application Publication
(10) Pub. No.: US 2025/0224511 A1
(43) Pub. Date: Jul. 10, 2025

(54) RADAR APPARATUS AND RADAR APPARATUS SUPPORT STRUCTURE

(71) Applicant: TOYOTA JIDOSHA KABUSHIKI KAISHA, Toyota-shi (JP)

(72) Inventors: Tetsuro ENOMOTO, Toyota-shi (JP); Masayuki AMANO, Nisshin-shi (JP); Kazuhito TOMIKI, Toyota-shi (JP); Hiranori ADACHI, Toyota-shi (JP)

(73) Assignee: TOYOTA JIDOSHA KABUSHIKI KAISHA, Toyota-shi (JP)

(21) Appl. No.: 19/013,345

(22) Filed: Jan. 8, 2025

(30) Foreign Application Priority Data
Jan. 10, 2024 (JP) 2024-001949

(51) Int. Cl. G01S 13/931; G01S 7/02

(52) U.S. Cl. CPC G01S 13/931; G01S 7/027; G01S 2013/93275

(57) ABSTRACT

A bracket is arranged at a position offset from the center of gravity of a radar main body in a thickness direction thereof. The bracket includes a fastening piece and a first rib. The fastening piece has an opposing surface opposed to a front bumper or an emblem plate, and the opposing surface faces the same direction as a radiation plane of the radar main body. The first rib is disposed in an upright position on the fastening piece, and extends from a box-shaped component to an end of the fastening piece in the vehicle width direction.

### CROSS REFERENCE TO RELATED APPLICATION

This application claims priority to Japanese Patent Application No. 2024-001949 filed on Jan. 10, 2024, which is incorporated herein by reference in its entirety including the specification, claims, drawings, and abstract.

### TECHNICAL FIELD

The present specification discloses a radar apparatus and a radar apparatus support structure.

### BACKGROUND

For example, JP 2022-136378 A discloses a millimeter-wave radar disposed on a vehicle front surface. The radar is housed in a casing. Brackets are protruded from side surfaces of the casing. Fastening holes are bored through the brackets, and the brackets are fastened to, for example, a front bumper.

In JP 2015-140029 A, a millimeter-wave radar is also disposed on a vehicle front surface. The radar is housed in a casing. Plate-shaped fixture members are protruded from side surfaces of the casing. Holes are bored through the fixture members, and the fixture members are fastened through the holes to a front grill, for example. A root portion of each of the fixture members is designed to be narrower than a tip end portion. For this reason, the root portion of the fixture member will be broken at the time of a head-on collision. This causes the casing to downwardly move (escape). Meanwhile, a stiffening rib is disposed on the root portion of the fixture member. When the root portion is provided with the rib, the casing is firmly supported during normal driving. The rib is formed only on the root portion of the fixture member. This means that an end position of the rib will be a breaking point. In other words, the breaking point can be controlled by means of the rib.

For example, a heat source, such as a drive source, is installed in a vehicle front region. Because of this, a region around the millimeter-wave radar is exposed to high temperatures. In a case where a bracket of the radar is formed of resin, thermal creep develops on the bracket at high temperatures. When the bracket is deformed due to the thermal creep, a radiation plane of the millimeter-wave radar may be inclined. In this case, it becomes necessary to adjust the horizontal direction and the vertical direction in the millimeter-wave radar. Such adjustment is also referred to as aiming.

Under the circumstances, the present specification discloses a radar apparatus and a radar apparatus support structure in which thermal creep of a support member can be suppressed.

### SUMMARY

A radar apparatus disclosed herein includes a radar main body and a housing. The radar main body has a radiation plane. The housing is configured to house the radar main body, and includes a box-shaped component and a bracket. The box-shaped component houses the radar main body. The bracket is protrudingly disposed on the box-shaped member and is fastened to a bumper or an emblem plate. The bracket is composed of a resin material. Further, the bracket is placed at a position offset from the center of gravity of the radar main body in the thickness direction of the radar main body. Still further, the bracket includes a fastening piece and a rib. The fastening piece has an opposing surface which is opposed to the bumper or the emblem plate, the opposing surface facing the same direction as the radiation plane. An insertion through hole is bored thorough the fastening piece. The rib is disposed in an upright position on the fastening piece. The rib includes a first rib extending from the box-shaped component to an end of the fastening piece in the vehicle width direction.

The placement of the bracket offset from the center of gravity of the radar main body in the thickness direction thereof generates a moment causing the radiation plane to be inclined. As a result, a bending moment acts on the fastening piece, and the bending moment causes the fastening piece to be bent in the shape of an arch. However, compressive rigidity and tensile rigidity of the first rib disposed in the upright position over the entire length of the fastening piece function to inhibit bending deformation of the fastening piece over the entire length thereof.

In the above-described configuration, the rib may further include a second rib perpendicular to the first rib.

When the moment causing the radiation plane to be inclined is generated, a torsional moment (torque) is applied to the bracket. The second rib which is perpendicular to the first rib, i.e., which extends along the width direction of the fastening piece, inhibits the bracket from getting twisted due to the torsional moment.

Further, in the above-described configuration, the first rib and the second rib may be disposed on the opposing surface of the fastening piece. In this case, a pair of first ribs and a pair of second ribs form a guide tube.

With the above-described configuration, when a guide protrusion is formed on the bumper or the emblem plate, it becomes possible to enable positioning and temporary fixation of the radar apparatus using the guide tube.

In an aspect of the present specification, a radar apparatus support structure is disclosed. The radar apparatus support structure includes the above-described radar apparatus and the bumper or the emblem plate configured to fasten the radar apparatus. The guide tube surrounds the insertion through hole. The bumper or the emblem plate has an insertion cylinder to be inserted into the guide tube.

When the insertion cylinder is inserted into the guide tube, the radar apparatus is temporarily fixed to the bumper or the emblem plate. In this state, a screw is screwed through the insertion through hole of the guide tube into the insertion cylinder, to fasten the radar apparatus to the bumper or the emblem plate. In this case, even when so-called non-rotational looseness occurs in a fastening region due to thermal creep, a holding structure in which the insertion cylinder is surrounded and held by the guide tube can inhibit relative displacement between the radar apparatus and the bumper or the emblem plate.

In an aspect of the present disclosure, another radar apparatus support structure is disclosed. The radar apparatus support structure includes the above-described radar apparatus and the bumper or the emblem plate configured to fasten the radar apparatus. A guide tube surrounds an insertion through hole. The bumper or the emblem plate has a depression into which the guide tube is inserted. A fastening hole to be axially aligned with the insertion through hole is bored in the bottom of the depression.

According to the above-described configuration, when the guide tube is inserted into the depression, the radar apparatus is temporarily fixed to the bumper or the emblem plate. In this state, a screw is inserted through the insertion through hole of the guide tube and screwed into the fastening hole to thereby fasten the radar apparatus to the bumper or the emblem plate. Even when the so-called non-rotational looseness occurs in the fastening region due to thermal creep, a holding structure in which the guide tube is held in the depression can inhibit relative displacement between the radar apparatus and the bumper or the emblem plate.

Further, in the above-described configuration, the radar apparatus may be fastened to the bumper or the emblem plate with the radiation plane arranged in a vertical position. In this case, a plurality of brackets are disposed on an upper portion of the box-shaped component.

When the plurality of brackets are mounted at positions distant from the center of gravity of the radar apparatus, i.e., positions where the moment is relatively great, the generated moment is distributed among the plurality of brackets.

In the above-described configuration, the opposing surface of the fastening piece may be separated farther way from the radiation plane than the rear surface of the box-shaped component is.

The placement of the fastening piece separated farther away from the radiation plane than the box-shaped component can prevent fastening points being exposed to the outside of the vehicle even when the radiation plane is exposed at the front surface of the vehicle.

According to the radar apparatus and the radar apparatus support structure disclosed herein, thermal creep of the support component can be suppressed.

### BRIEF DESCRIPTION OF DRAWINGS

Embodiments of the present disclosure will be described based on the following figures, wherein:

FIG. 1 is an exploded perspective view illustrating a radar apparatus according to a first embodiment, and a bumper configured to fasten the radar apparatus;

FIG. 2 is a perspective view illustrating a structure of the radar apparatus according to the first embodiment, viewed from a radiation plane side;

FIG. 3 is a perspective view illustrating a structure of the radar apparatus according to the first embodiment, viewed from a rear surface side;

FIG. 4 is a perspective view for explaining loads applied to a bracket;

FIG. 5 is an exploded perspective view illustrating the radar apparatus according to the first embodiment, and an emblem plate configured to fasten the radar apparatus;

FIG. 6 is an exploded perspective view illustrating a radar apparatus according to a second embodiment, and a bumper configured to fasten the radar apparatus;

FIG. 7 is a perspective view illustrating a structure of the radar apparatus according to the second embodiment, viewed from a radiation plane side;

FIG. 8 is a perspective view illustrating a structure of the radar apparatus according to the second embodiment, viewed from a rear surface side;

FIG. 9 is a perspective view for explaining a process (1/2) to fasten the radar apparatus according to the second embodiment to the bumper;

FIG. 10 is a cross sectional view taken along line A-A indicated in FIG. 9;

FIG. 11 is a perspective view for explaining a process (2/2) to fasten the radar apparatus according to the second embodiment to the bumper;

FIG. 12 is a cross sectional view taken along line B-B indicated in FIG. 11;

FIG. 13 is an exploded perspective view illustrating the radar apparatus according to the second embodiment and an emblem plate configured to fasten the radar apparatus;

FIG. 14 is a cross-sectional view illustrating a state where the radar apparatus according to the second embodiment is fastened to the emblem plate, taken at the same position as the cross-sectional view in FIG. 12;

FIG. 15 is an exploded perspective view illustrating a radar apparatus according to a third embodiment and a bumper configured to fasten the radar apparatus;

FIG. 16 is a perspective view illustrating a structure of the radar apparatus according to the third embodiment, viewed from the radiation plane side; and

FIG. 17 is an exploded perspective view illustrating the radar apparatus according to the third embodiment and an emblem plate configured to fasten the radar apparatus.

### DESCRIPTION OF EMBODIMENTS

Hereinafter, a radar apparatus and a radar apparatus support structure will be explained with reference to the drawings. Shapes, materials, the number of components, and numerical values described below are presented as examples for explanation. The shapes and other features may be changed as appropriate depending on specifications of the radar apparatus and the radar apparatus support structure. In the drawings, identical or equivalent components are identified by identical reference signs.

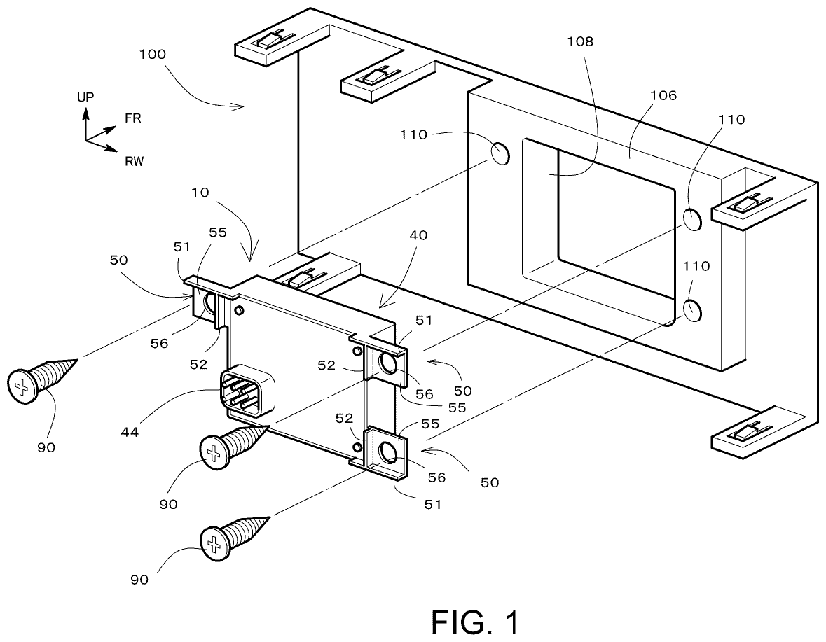

In FIGS. 1 to 17, the longitudinal direction of a vehicle is indicated by an FR axis, the width direction of the vehicle is indicated by an RW axis, and the height direction of the vehicle is indicated by an UP axis. The FR axis, the RW axis, and the UP axis are perpendicular to each other. The FR axis has the positive direction on its forward side. The RW axis has the positive direction on its right side. The UP axis has the positive direction on its upper side.

### 1. General Configuration (Common Configuration in Embodiments 1 to 3)

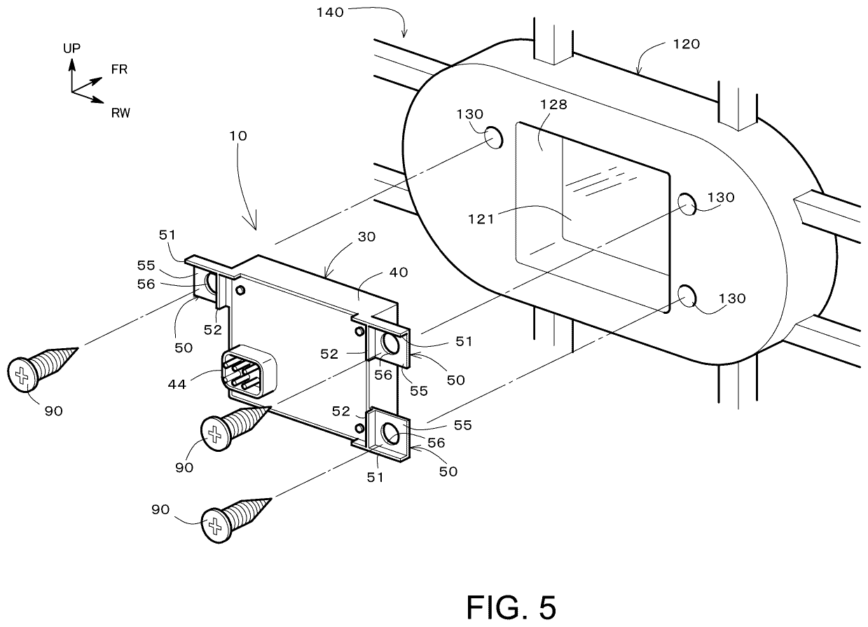

A radar apparatus 10 according to an embodiment is disclosed in FIG. 1. FIG. 1 further illustrates a front bumper 100 to which the radar apparatus 10 is fastened. In this specification, the radar apparatus 10 and the front bumper 100 or an emblem plate 120 (see FIG. 5) constitute a radar apparatus support structure.

The front bumper 100 is a shock absorbing component mounted on a front surface of a vehicle. The front bumper 100 is formed of, for example, a resin material. For example, the front bumper 100 is a dividable component, and a plurality of parts divided from the front bumper 100 are attached to the front surface of the vehicle. For example, in the example shown in FIG. 1, the front bumper 100 is clipped to surrounding components around the front bumper 100. The front bumper 100 may be bolted to the surrounding components rather than being clipped thereto.

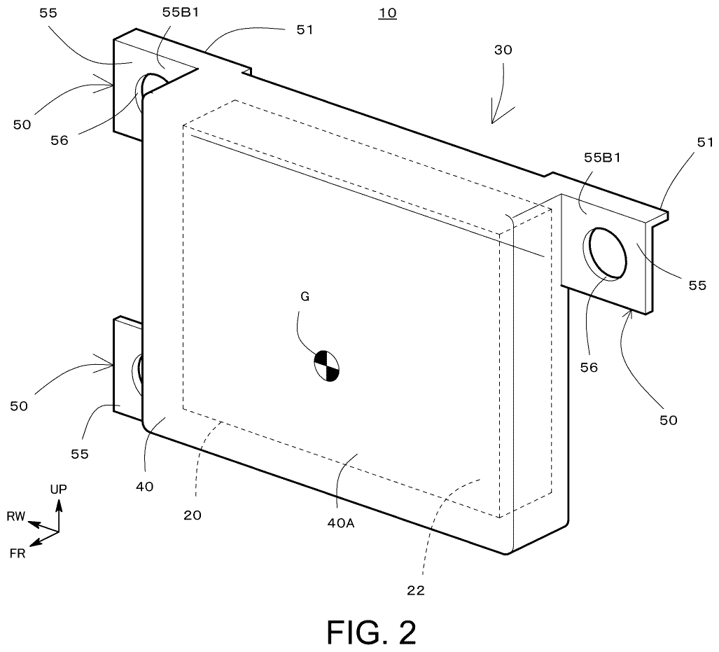

The front bumper 100 has a frame 106. The frame 106 is a thick frame body for mounting the radar apparatus 10. The frame 106 has a rectangular shape, for example. A rectangular opening 108 is formed in the center of the frame 106. The opening 108 has a shape conforming to a shape of a box-shaped component 40 of the radar apparatus 10. For example, a front surface 40A (see FIG. 2) of the box-shaped component 40 is exposed through the opening 108 to a region outside the vehicle.

The frame 106 has fastening holes 110. The fastening holes 110 are bored, for example, in a rear surface of the frame 106. It should be noted that the rear surface of the frame 106 is a surface facing the inside of the vehicle. The fastening holes 110 are formed, for example, beside the opening 108 on both sides thereof. As will be described below, each of the fastening holes 110 is axially aligned with an insertion through hole 56 which is bored through a bracket 50 of the radar apparatus 10. A screw 90 is screwed into the fastening hole 110. The screw 90 is a so-called self-tapping screw which is inserted into the fastening hole 110 while forming threads on an inner circumferential surface of the fastening hole 110.

It should be noted that FIG. 1 shows the front bumper 100 as an example of a fastening component for the radar apparatus 10, although the radar apparatus 10 may be fastened to a rear bumper. As in the case of the front bumper 100, the frame 106 is also disposed on the rear bumper. The radar apparatus 10 is fastened to the frame 106 of the rear bumper.

Referring to FIG. 5, an emblem plate 120 is supported, for example, by a front grille 140. The emblem plate 120 is positioned at the center in the vehicle width direction on the front surface of the vehicle. For example, the emblem plate 120 is formed of a resin material.

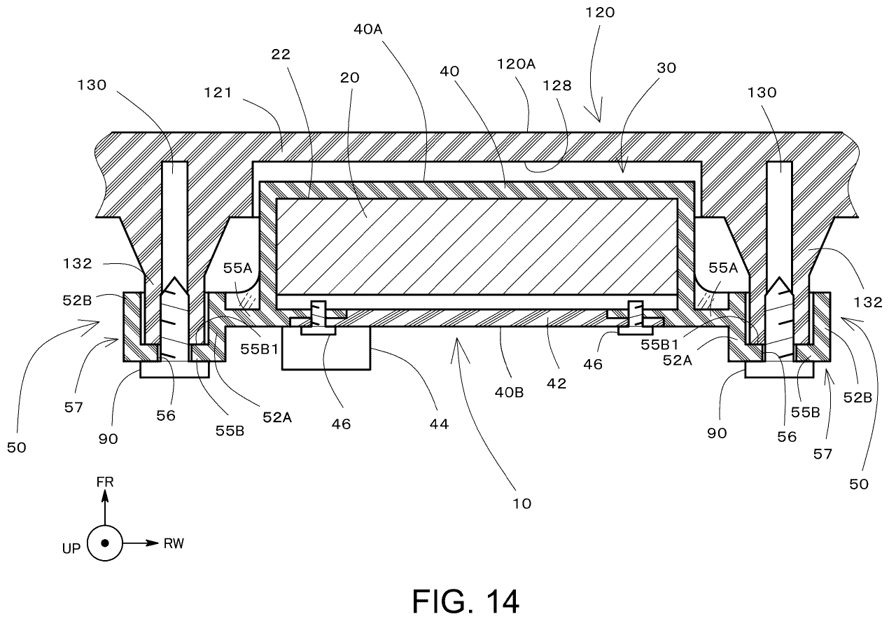

The emblem plate 120 has a design surface 120A (see FIG. 14) to be exposed to the outside. A recess 128 is formed in the center on a rear surface of the emblem plate 120. The rear surface of the emblem plate 120 is a surface opposite the design surface 120A. A front wall 121 is disposed on the bottom of the recess 128. The recess 128 has a rectangular shape, and at least the front surface 40A of the radar apparatus 10 is inserted into the recess 128. In addition, a predetermined clearance is created, for example, between the front surface 40A of the radar apparatus 10 and the bottom of the recess 128.

In the rear surface of the emblem plate 120, fastening holes 130 are bored. The fastening holes 130 are formed, for example, beside the recess 128 on both sides thereof. As will be described below, each fastening hole 130 is axially aligned with the insertion through hole 56 bored through the bracket 50 of the radar apparatus 10. As in the case of the fastening hole 110 in the front bumper 100, the screw 90 is screwed in the fastening hole 130. In the screwing process, threads are formed on the inner circumferential surface of the fastening hole 130.

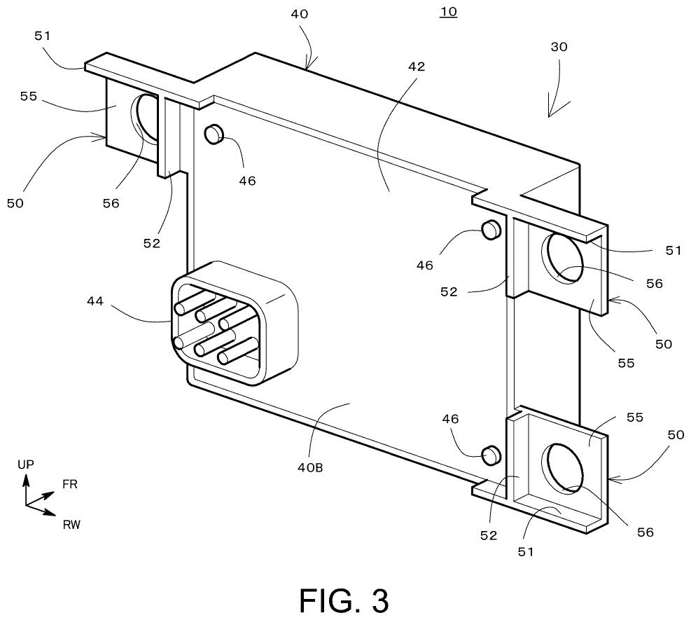

Referring to FIGS. 2 and 3, the radar apparatus 10 is a substantially rectangular apparatus. The radar apparatus 10 has a radar main body 20 and a housing 30. The radar main body 20 incorporates a radar antenna and a circuit board. A surface where the radar antenna is placed is a radiation plane 22. The circuit board incorporates a millimeter wave oscillator. This means that the radar apparatus 10 is a millimeter wave radar apparatus. In addition, the radar main body 20 has, for example, a laterally elongated shape whose dimension along the width direction (RW axis direction) is greater than that along the height direction (UP axis direction).

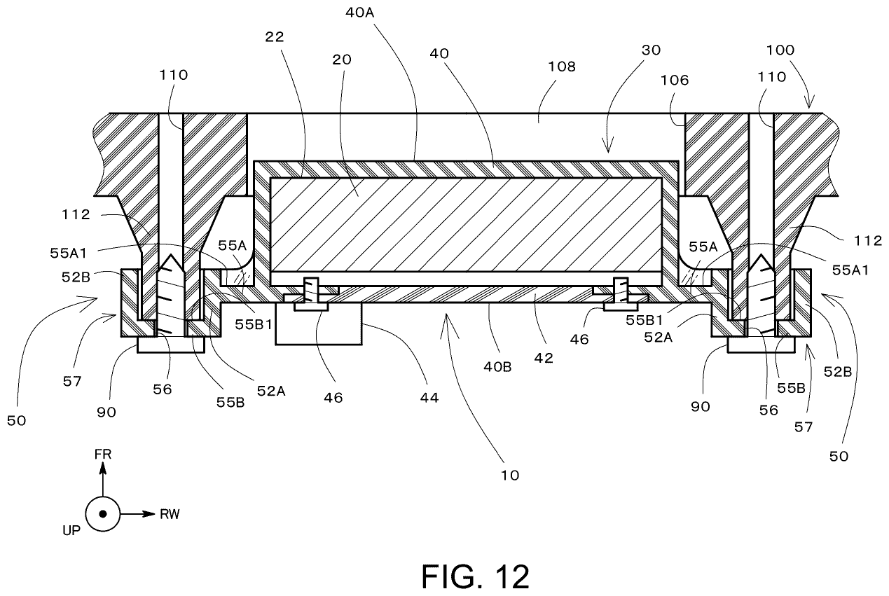

The radar main body 20 is housed in the housing 30. The housing 30 is a molded component formed by means of a resin material, for example. The housing 30 has the box-shaped component 40 and the bracket 50. The box-shaped component 40 is configured to store the radar main body 20. For example, the box-shaped component 40 is open on its rear side, and the open rear side of the box-shaped component 40 is closed by a lid 42. As illustrated in FIG. 12, for example, the lid 42 is fastened to the box-shaped component 40 by bolts 46. A connector 44 is mounted on the lid 42. Data on an electromagnetic wave (reflected wave) received by the radar main body 20 is transmitted through the connector 44 to an ECU (Electronic Control Unit) installed in the vehicle.

Referring again to FIGS. 2 and 3, the bracket 50 is protruded from the box-shaped component 40. The bracket 50 is the fastening component which is fastened to the front bumper 100 or the emblem plate 120 (see FIG. 5). For example, the bracket 50 is protrudingly attached to the box-shaped component 40 on each side surface thereof in the vehicle width direction.

For example, a plurality of brackets 50 are disposed on the radar apparatus 10 in first to third embodiments described below. For example, the radar apparatus 10 has three brackets 50. That is, the radar apparatus 10 is supported in a three point mounting manner by the front bumper 100 or the emblem plate 120.

Among the brackets 50, two or more brackets 50 are disposed on an upper portion of the box-shaped component 40. For example, in the upper portion of the box-shaped component 40, the two or more brackets 50 are protrudingly provided on both side surfaces in the vehicle width direction. For example, each of the two or more brackets 50 is protruded in the vehicle width direction from a corresponding one of the side surfaces of the box-shaped component 40 at an upper end thereof. Further, in a lower portion of the box-shaped component 40, the bracket 50 is protrudingly provided on one of the side surfaces in the vehicle width direction. For example, the bracket 50 is protruded in the vehicle width direction from the one of the side surfaces of the box-shaped component 40 at a lower end thereof.

Each of the brackets 50 includes a fastening piece 55. The fastening piece 55 is brought into contact with the side surface of the box-shaped component 40 and protruded therefrom in the vehicle width direction (the RW axis direction). The fastening piece 55 is a piece of a flat plate having an opposing surface 55B1 which is opposed to the front bumper (see FIG. 1) or the emblem plate 120 (see FIG. 5), and the opposing surface 55B1 faces the same direction as the radiation plane 22. The insertion through hole 56 is bored through the fastening piece 55 in the thickness direction thereof. The insertion through hole 55 is axially aligned with the fastening hole 110 in the front bumper 100 or the fastening hole 130 in the emblem plate 120 (see FIG. 5).

Referring to FIG. 2, the radiation plane 20 is arranged in a vertical position and secured in this position to the front bumper 100 or the emblem plate 120. The bracket 50 is placed at a position offset from the center of gravity G of the radar main body 20 in the thickness direction of the radar main body 20 (FR axis direction). Such placement of the bracket 50, being the support component offset from the center of gravity G, generates a moment which causes the radar apparatus 10 to be inclined. When the two or more brackets 50 are disposed on upper positions distant from the center of gravity G, loads to be transferred to the brackets 50 are distributed among the two or more brackets 50.

The bracket 50 is disposed, for example, at a position close to the rear surface of the box-shaped component 40. For example, on the side surface of the box-shaped component 40, the bracket 50 is protrudingly placed at the rear end of the box-shaped component 40. In this way of placement, the front surface 40A of the box-shaped component 40 can be inserted into the opening 108 of the front bumper 100 or into the recess 128 of the emblem plate 120 (see FIG. 5). In addition, the insertion through hole 56 in the bracket 50 is axially aligned with the fastening hole 110 in the front bumper 100 or the fastening hole 130 in the emblem plate 120. Even in a case where the front surface 40A of the box-shaped component 40 is exposed to the region outside the vehicle, because the bracket 50 is placed as illustrated in FIG. 1, for example, inside the vehicle, a fastening point is not exposed to the region outside the vehicle.

The placement of the bracket 50 shifted from the center of gravity G (see FIG. 2) of the radar main body 20 toward the rear surface thereof generates a moment which causes the radar main body 20 to fall forward. As described above, the fastening piece 55 is a piece of a flat plate, and the opposing surface 55B1 opposed to the front bumper 100 (see FIG. 1) or the emblem plate 120 (see FIG. 5) faces the same direction as the radiation plane 22. Therefore, the fastening piece 55 is placed in a position where the fastening piece 55 is relatively easily deformed due to thermal creep by the forward falling moment.

A first rib 51 and a second rib 52 are provided on each bracket 50 in the below-described first to third embodiments in order to suppress the thermal creep of the bracket 50 resulting from the forward falling moment. The first rib 51 functions to inhibit bending deformation of the bracket 50. In addition, the second rib 52 functions to inhibit torsional deformation of the bracket 50.

In the below-described first to third embodiments, the brackets 50 having different configuration are provided. However, the first rib 51 and the second rib 52 are provided as common features in all of the brackets 50 according to the embodiments. As will be described below, configurations of the front bumper 100 (see FIG. 1) and the emblem plate 120 (see FIG. 5) are changed in areas around the fastening holes 110 and 130 depending on the different structures of the brackets 50 in the first to third embodiments.

### 2. First Embodiment

With reference to FIGS. 2 and 3, the bracket 50 has the fastening piece 55, the first rib 51, and the second rib 52.

The fastening piece 55 is attached to the side surface of the box-shaped component 40 so as to be protruded therefrom in the width direction (RW axis direction). The fastening piece 55, being a piece of a flat plate, is provided in a position where the opposing surface 55B1 which is opposed to the front bumper (see FIG. 1) or the emblem plate 120 (see FIG. 5) faces the same direction as the radiation plane 22. The insertion through hole 56 is bored through the fastening piece 55 in the thickness direction thereof.

The first rib 51 and the second rib 52 are disposed so as to stand on the fastening piece 55. For example, the first rib 51 and the second rib 52 are disposed in upright positions perpendicular to the fastening piece 55. As illustrated in FIGS. 2 and 3, both the first rib 51 and the send rib 52 are provided on the rear surface of the fastening piece 55 in the first embodiment. The rear surface is a surface on the reverse side of the opposing surface 55B1.

The first rib 51 is a plate piece extending from the box-shaped component 40 to the end (the outer end in the width direction) of the fastening piece 55. For example, the first rib 51 is placed in an upright position perpendicular to a rear surface 40B of the box-shaped component 40 and extends along the vehicle width direction (RW axis direction). The first rib 51 is placed, for example, at an end edge (the end in the UP axis direction) of the fastening piece 55. In the examples shown in FIGS. 1 to 5, the first rib 51 is provided as a continuous extension of the upper surface or the lower surface of the box-shaped component 40. The first rib 51 extends along the horizontal plane (FR-RW plane).

The second rib 52 is a plate piece disposed on the fastening piece 55 in an upright position perpendicular to the first rib 51. For example, on the rear surface of the fastening piece 55, the second rib 52 is placed between the insertion through hole 56 and the side surface of the box-shaped component 40. For example, the second rib 52 is separated from the side surface of the box-shaped component 40 toward the outside in the width direction. Taking a vertical dimension (UP axis dimension) of the fastening piece 55 as a width dimension, the second rib 52 is provided over the entire width of the fastening piece 55, for example.

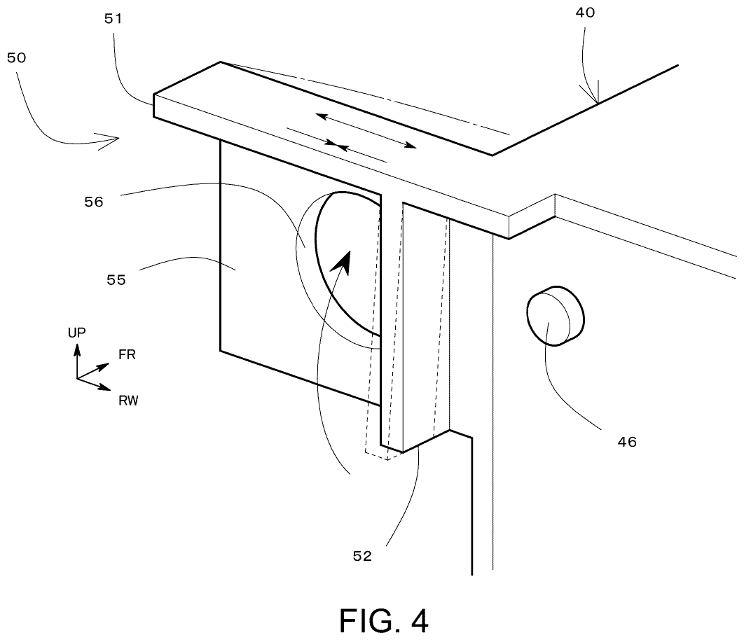

As described above, when the bracket 50 is mounted at the position offset from the center of gravity G of the radar main body 20, the moment causing the box-shaped component 40 to be forwardly inclined is generated. Referring to FIG. 4, the bracket 50 receives both a bending load causing the bracket 50 to be curved in the shape of an arc, as indicated by alternate long and short dashed lines, and a torsional load indicated by an arrow.

Deformation of the bracket 50 caused by the bending load is inhibited by the first rib 51. Specifically, when bending deformation occurs, a tensile load is exerted on a root portion (close to the fastening piece 55) of the first rib 51, while a compressive load is exerted on a roof portion of the first rib 51 as indicated by arrows. The direction in which the tensile and compressive loads are exerted lies along the longitudinal direction of the first rib 51, which means that the tensile load and the compression load are exerted in a direction in which the first rib 51 has high compressive rigidity and high tensile rigidity. Therefore, the bending deformation of the bracket 50 can be inhibited by the first rib 51 which resists both the tensile load and the compressive load over the entire length of the fastening piece 55.

Meanwhile, deformation of the bracket 50 caused by the tortional load is inhibited by the second rib 52. Specifically, the tortional load is exerted on the bracket 50, taking the RW axis direction as an axis of torsion. Then, a shearing load is exerted on the second rib 52 in the FR axis direction as illustrated by a broken line. The deformation of the bracket 50 can be inhibited by the second rib 52 which resists the shearing load.

Even through a region around the bracket is subjected to high temperatures, deformation (i.e., thermal creep) of the bracket 50 can be inhibited by the first rib 51 and the second rib 52 as described above. As a result, the inclining motion (forward falling) of the radiation plane 22 of the radar main body 20 can be prevented or suppressed.

### 3. Second Embodiment

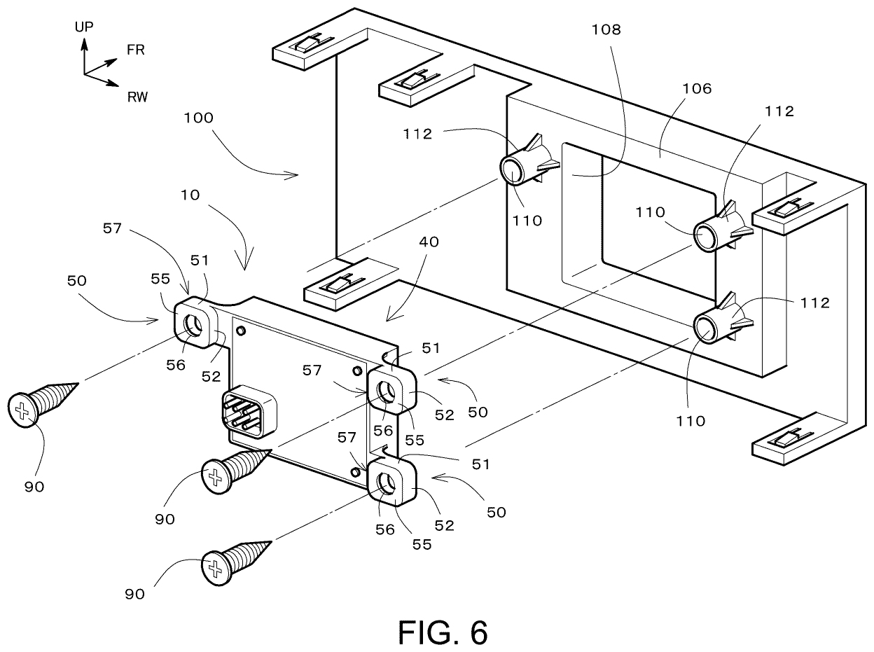

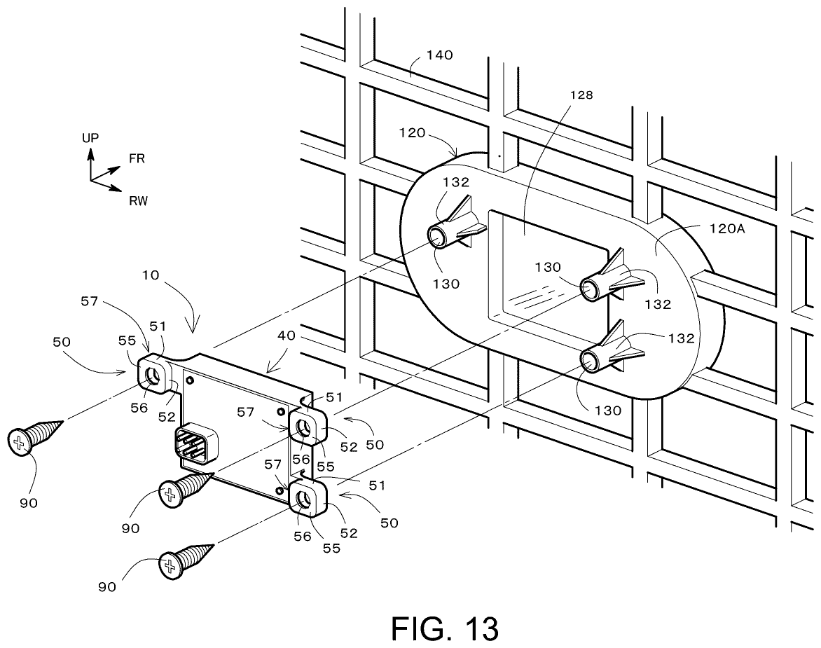

FIGS. 6 to 14 shows a radar apparatus 10 and a radar apparatus support structure according to a second embodiment. In the second embodiment, a guide tube 57 is disposed on the bracket 50. The guide tube 57 is formed by first ribs 51 and second ribs 52. In addition, insertion cylinders 112 are formed on the frame 106 of the front bumper 100. On the other hand, insertion cylinders 132 are formed on the emblem plate 120 (see FIG. 13).

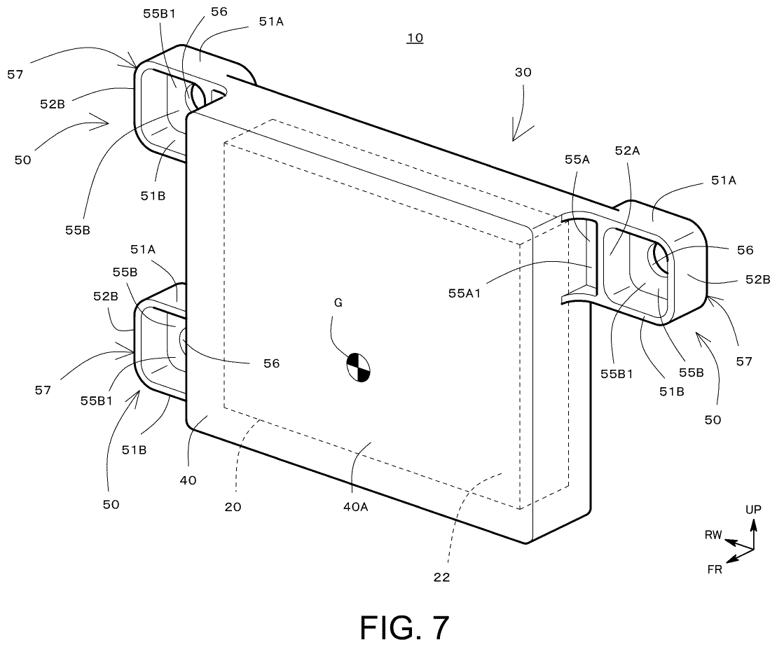

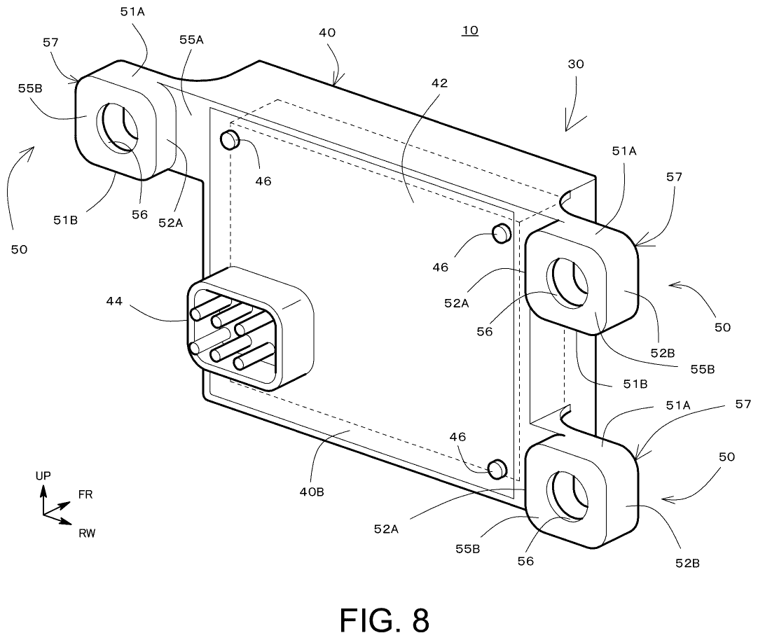

FIG. 7 shows a perspective view of the radar apparatus 10 viewed from a front surface 40A side. FIG. 8 shows a perspective view of the radar apparatus 10 viewed from a rear surface 40B side. Similarly to the radar apparatus 10 shown in FIGS. 2 and 3, brackets 50 are protrudingly disposed in the upper portion of the box-shaped component 40 on both side surfaces thereof in the vehicle width direction. Further, in the lower portion of the box-shaped component 40, a bracket 50 is protrudingly disposed on one of the side surfaces in the vehicle width direction. The brackets 50 are mounted at positions close to the rear surface of the box-shaped component 40.

Referring to FIGS. 7, 8, and 12, the bracket 50 has first ribs 51A and 51B, second ribs 52A and 52B, and fastening pieces 55A and 55B. A surface of each of the fastening pieces 55A and 55B that is opposed to the front bumper 100 (see FIG. 6) or the emblem plate 120 (see FIG. 13) faces the same direction as the radiation plane 22. An insertion through hole 56 is bored through the fastening piece 55B in the thickness direction thereof. In other words, taking the fastening pieces 55A and 55B as one integral piece constituting the fastening piece 55, the insertion through hole 56 is bored in the fastening piece 55 at a position slightly shifted outward in the vehicle width direction.

The first ribs 51A and 51B and the second ribs 52A and 52B are placed on opposing surfaces 55A1 and 55B1 of the fastening pieces 55A and 55B. The fastening piece 55A extends from the side surface of the box-shaped component 40 toward the outside in the vehicle width direction. The outer end, in the vehicle width direction, of the fastening piece 55A is connected to the second rib 52A. The rear end of the second rib 52A is connected to the fastening piece 55B. The insertion through hole 56 is bored through the fastening piece 55B. When a step structure is formed by means of the second rib 52A, the fastening piece 55B is placed further rearward than the rear surface 40B of the box-shaped component 40. In other words, as shown in FIG. 12, the opposing surface 55B1 is separated farther away from the radiation plane 22 of the radar main body 20 than the rear surface 40B of the box-shaped component 40 is.

When the opposing surface 55B1 of the fastening piece 55B is located farther away from the radiation plane 22 than the rear surface 40B of the box-shaped component 40 is, the fastening point can be prevented from being exposed to the region outside the vehicle even in a case where the radiation plane 22 is exposed at the front surface of the vehicle.

The first rib 51A is placed on the top ends of the fastening pieces 55A and 55B. The first rib 51B is placed on the lower ends of the fastening pieces 55A and 55B. The first ribs 51A and 51B are designed to extend from the side surface of the box-shaped component 40 to the outer end, in the vehicle direction, of the fastening piece 55B.

The second ribs 52A and 52B are perpendicular to the first ribs 51A and 51B. The second rib 52A is placed between the fastening pieces 55A and 55B. The second rib 52B is placed at the outer end, in the vehicle width direction, of the fastening piece 55B.

The first ribs 51A and 51B and the second ribs 52A and 52B constitute the guide tube 57. The guide tube 57 is a square tube. The rear end of the guide tube 57 is attached to the fastening piece 55B. That is, the guide tube 57 surrounds the insertion through hole 56.

Referring to FIG. 6, the insertion cylinders 112 are formed corresponding to the guide tubes 57 on the front bumper 100. The insertion cylinders 112 extend rearward in the vehicle from the rear surface of the frame 106. The insertion cylinders 112 are, for example, circular cylinders. A root portion (joint portion with the frame) of each of the insertion cylinders 112 has reinforcing ribs. FIG. 12 shows that inner bores of the insertion cylinders 112 are used as the fastening holes 110.

Referring to FIG. 13, the insertion cylinders 132 are formed on the emblem plate 120 so as to correspond to the guide tubes 57. The insertion cylinders 132 extend rearward in the vehicle from the rear surface of the emblem plate 120. The insertion cylinders 132 are, for example, circular cylinders. A root portion of each of the insertion cylinders 132 has reinforcing ribs. FIG. 14 shows that inner bores of the insertion cylinders 132 are used as the fastening holes 130.

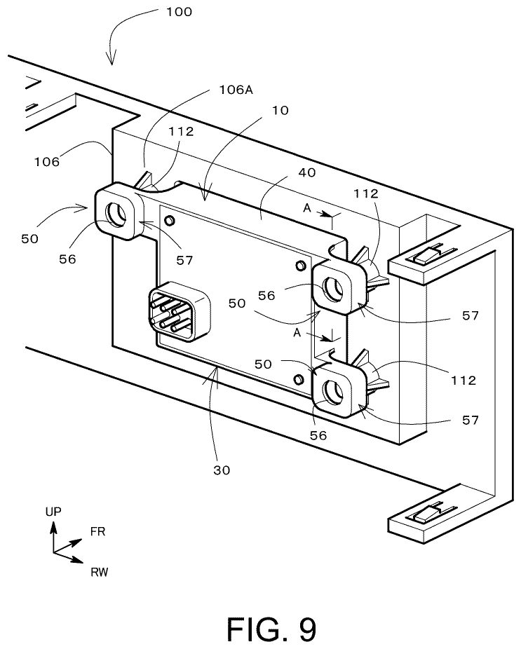

FIGS. 9 to 12 show a process of fastening the radar apparatus 10 to the front bumper 100. Referring to FIG. 9, the guide tubes 57 of the radar apparatus 10 are placed on the corresponding insertion cylinders 112 of the front bumper 100. The rear end of each of the insertion cylinders 112 is brought into contact with the fastening piece 55B.

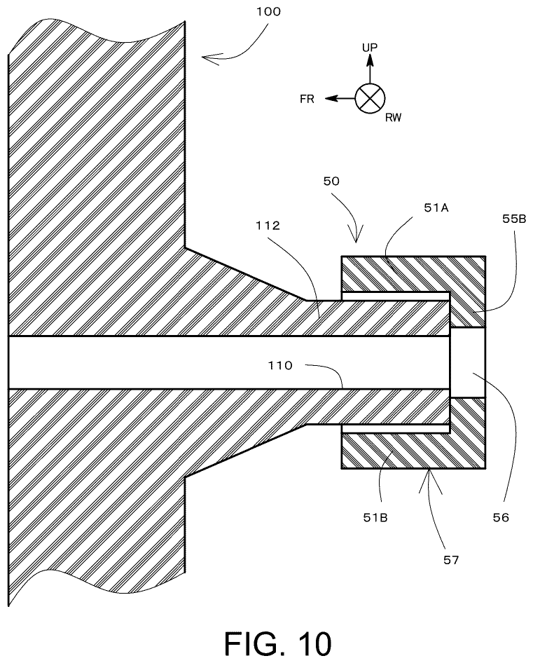

In this state, as illustrated in FIG. 10, the guide tube 57 is caught by the insertion cylinder 112, which prevents the radar apparatus 10 from falling off from the front bumper 100. In other words, the guide tube 57 and the insertion cylinder 112 cooperatively function to temporarily fix the radar apparatus 10 to the front bumper 100. This allows a worker to temporarily release their hand from the radar apparatus 10 in order to go and fetch screws and tools.

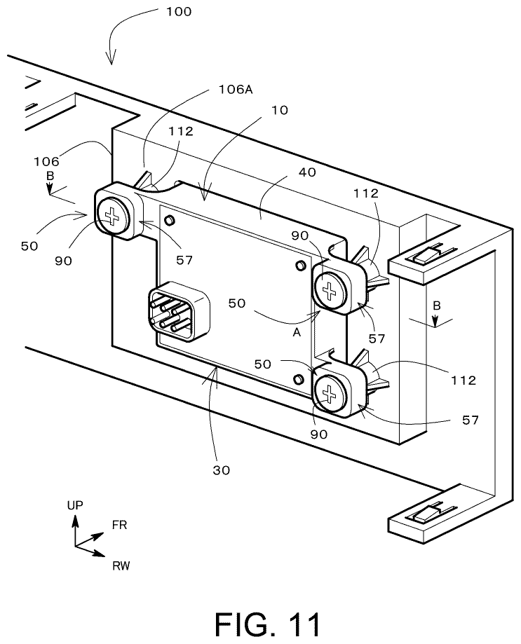

Further, when the guide tube 57 is slipped onto the insertion cylinder 112 of the front bumper 100, the insertion hole 56 is aligned with the fastening hole 110. As illustrated in FIGS. 11 and 12, the screw 90 is screwed through the insertion through hole 56 into the fastening hole 110. The screw 90 is screwed while forming threads on the inner circumferential surface of the fastening hole 120, to thereby fasten the radar apparatus 10 to the front bumper 100.

FIGS. 13 and 14 show a process of fastening the radar apparatus 10 to the emblem plate 120. Referring to FIG. 13, the guide tubes 57 of the radar apparatus 10 are placed on the insertion cylinders 132 of the emblem plate 120. The rear end of each of the insertion cylinders 132 is brought into contact with the fastening piece 55B. This allows the radar apparatus 10 to be temporarily fixed to the emblem plate 120. Thereafter, the screw 90 is screwed through the insertion hole 56 into the fastening hole 130. The screw 90 is screwed while forming threads on the inner circumferential surface of the fastening hole 130, to thereby fasten the radar apparatus 10 to the emblem plate 120.

As has been described above, the first ribs 51A and 51B and the second ribs 52A and 52B constitute the guide tube 57. That is, the rib members provided to inhibit the thermal creep of the bracket 50 can be also used as a temporary fixation means for the radar apparatus 10.

In addition, when a fastening force is decreased due to the thermal creep, a combination of the guide tube 57 and the insertion cylinder 112 or 132 functions to reduce a variation in a relative position between the radar apparatus 10 and the front bumper 100 or the emblem plate 120. The fastening piece 55B is fastened to the insertion cylinder 112 or 132 by means of the screw 90. At this time, an axial force acts on contact ends of the fastening piece 55B and the insertion cylinder 112 or 132. Thermal creep causes so-called stress relaxation, and accordingly causes the fastening piece 55B to be deformed and depressed, which may, in turn, decrease the fastening force. That is, so-called non-rotational loosening may occur.

In this embodiment, the insertion cylinder 112 or 132 is inserted into the guide tube 57. In other words, the insertion cylinder 112 or 132 is held in the guide tube 57. Therefore, even when the fastening force applied by the screw 90 is decreased, the variation in the relative position between the radar apparatus 10 and the front bumper 100 or the emblem plate 120 can be prevented by the structure of holding the insertion cylinder 112 or 132 within the guide tube 57.

### 4. Third Embodiment

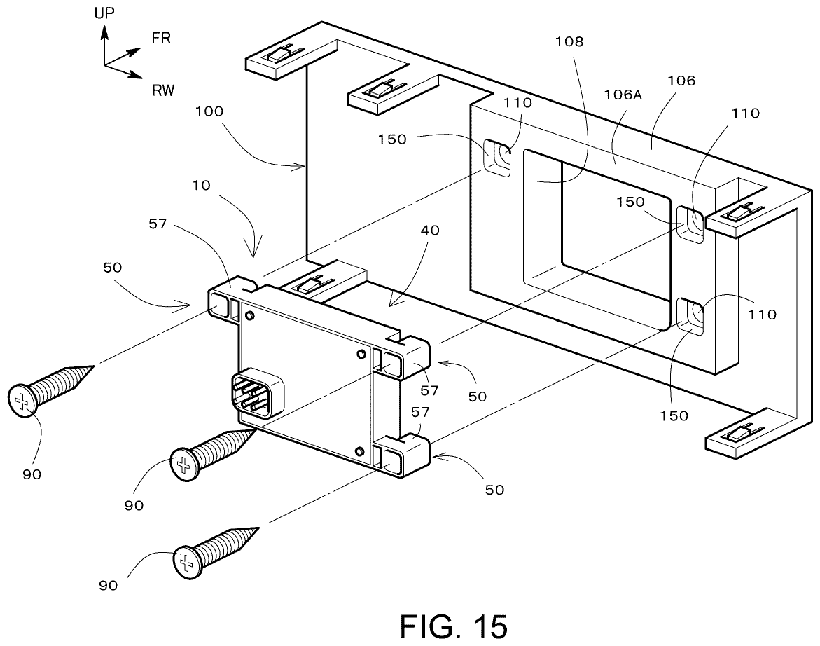

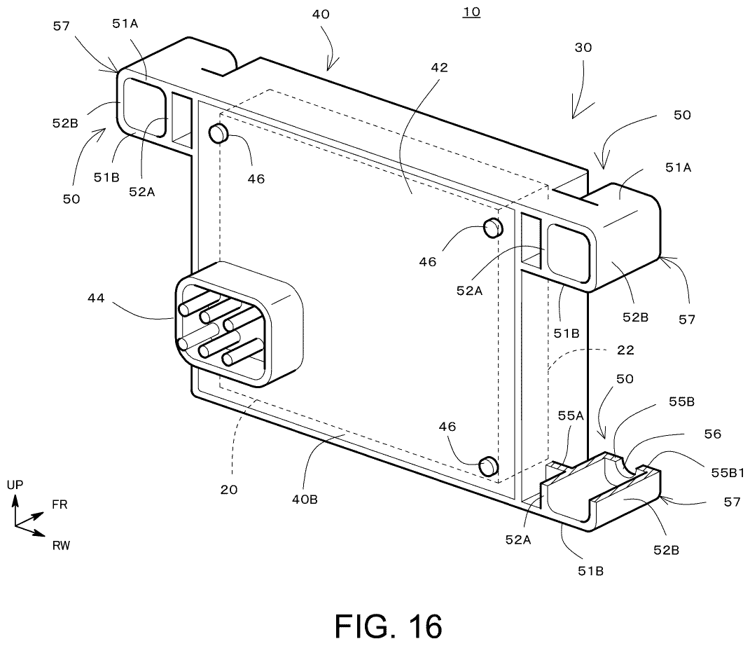

FIGS. 15 to 17 illustrate a radar apparatus and a radar apparatus support structure according to a third embodiment. FIG. 16 shows a perspective view of the radar apparatus 10 alone. As in the case of FIGS. 2 and 3, in the upper portion of the box-shaped component 40, brackets 50 are protrudingly disposed on both side surfaces thereof in the vehicle width direction. Further, in the lower part of the box-shaped component 40, a bracket 50 is protrudingly disposed on one of the side surfaces in the vehicle width direction. The brackets 50 are attached at positions close to the rear surface of the box-shaped component 40. It should be noted that the three brackets 50 illustrated in FIG. 16 are identical in shape. The cross sectional structure is illustrated with respect to one of the brackets 50 that is disposed in the lower portion.

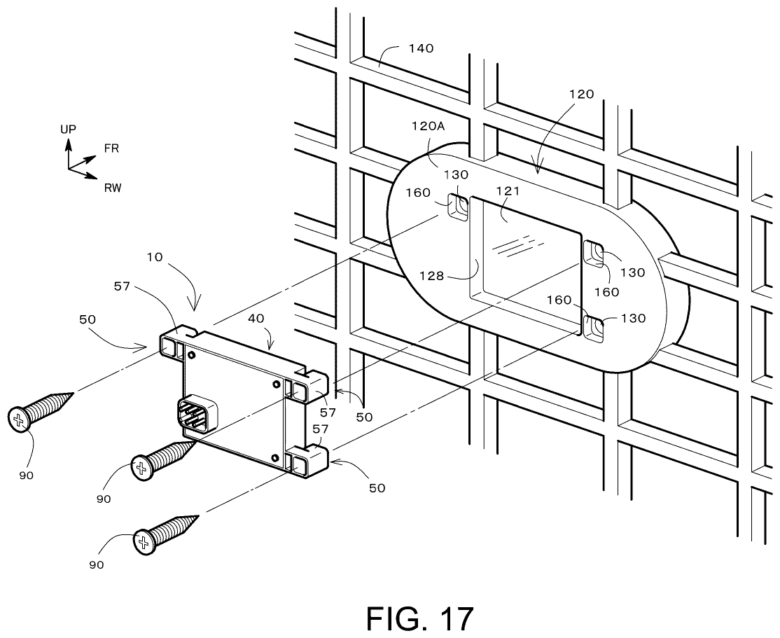

Each of the brackets 50 has first ribs 51A and 51B, second ribs 52A and 52B, and fastening pieces 55A and 55B. Each of the fastening pieces 55A and 55B has an opposing surface opposed to the front bumper 100 (see FIG. 15) or the emblem plate 120 (see FIG. 17), and the opposing surface faces the same direction as the radiation plane 22. An insertion through hole 56 is formed penetrating through the fastening piece 55B in the thickness direction thereof. Taking the fastening pieces 55A and 55B as one integral piece, being the fastening piece 55, the insertion through hole 56 is bored through the fastening piece 55 at a location slightly shifted outward in the vehicle width direction.

The fastening piece 55A extends outward in the vehicle width direction from the side surface of the box-shaped component 40. The outer end of the fastening piece 55A in the vehicle width direction is joined to the second rib 52A. The front end of the second rib 52A is joined to the fastening piece 55B. An insertion hoe 56 is bored through the fastening piece 55B.

The first rib 51A is disposed on upper ends of the fastening pieces 55A and 55B. The first rib 51B is disposed on lower ends of the fastening pieces 55A and 55B. The first ribs 51A and 51B extend from the side surface of the box-shaped component 40 to the outer end of the fastening piece 55B in the vehicle width direction.

The second ribs 52A and 52B are perpendicular to the first ribs 51A and 51B. The second rib 52A is arranged between the fastening pieces 55A and 55B. The second rib 52B is placed on the outer end of the fastening piece 55B in the vehicle width direction.

The first ribs 51A and 51B and the second ribs 52A and 52B constitute the guide tube 57. The guide tube 57 is a rectangular tube. The guide tube 57 is attached at its front end to the fastening piece 55B. That is, the guide tube 57 surrounds the insertion through hole 56.

Referring to FIG. 15, depressions 150 are formed corresponding to the guide tubes 57 in the front bumper 100. The depressions 150 are formed in the rear surface of the frame 106. Each of the depressions 150 is formed in the shape of a rectangular hole conforming to a shape of the guide tube 57. The depression 150 has a bottom in which the fastening hole 110 is bored.

Referring to FIG. 17, depressions 160 are formed corresponding to the guide tubes 57 in the emblem plate 120. The depressions 160 are formed in the rear surface of the emblem plate 120. Each of the depressions 160 is formed in the shape of a rectangular hole conforming to a shape of the guide tube 57. The depression 160 has a bottom in which the fastening hole 130 is bored.

Referring back to FIG. 15, when the radar apparatus 10 is fastened to the front bumper 100, the guide tubes 57 of the radar apparatus 10 are inserted into the depressions 150 in the front bumper 100. Then, the fastening pieces 55B disposed at the front ends (see FIG. 16) of the guide tubes 57 are brought into contact with the bottoms of the depressions 150. This causes the insertion holes 56 in the fastening pieces 55B to be aligned with the fastening holes 110 in the depression 150.

The radar apparatus 10 is temporarily fixed to the front bumper 100 by inserting the guide tubes 57 into the depressions 150 in the front bumper 100. This allows the worker to temporarily release their hand from the radar apparatus 10 in order to go and fetch screws and tools. Then, the screws 90 are inserted through the insertion through holes 56 into the fastening holes 110 while forming threads therein, to thereby fasten the radar apparatus 10 to the front bumper 100.

Referring again to FIG. 17, the radar apparatus 10 is fastened to the emblem plate 120 by inserting the guide tubes 57 of the radar apparatus 10 into the corresponding depressions 160 in the emblem plate 120. Then, the fastening pieces 55B disposed at the front ends of the guide tubes 57 (see FIG. 16) are brought into contact with the bottoms of the depressions 160. This causes the insertion through holes 56 in the fastening pieces 55B to be aligned with the fastening holes 130 in the depressions 160.

When the guide tubes 57 are inserted into the depressions 160 in the emblem plate 120, the radar apparatus 10 is temporarily fixed to the front bumper 100. Then, the screws 90 are inserted through the insertion through holes 56 into the fastening holes 130 while forming threads therein, to thereby fasten the radar apparatus 10 to the front bumper 100.

As described above, when the fastening piece 55B is dented due to the thermal creep, the fastening force applied by the screw 90 is decreased. If this is the case, the holding structure implemented by the guide tubes 57 and the depressions 150 or 160 can inhibit a variation in the relative position between the radar apparatus 10 and the front bumper 100 or the emblem plate 120.

The present disclosure is not limited to the embodiments described above, and may embrace all changes and modifications without departing from the technical scope or the essence of the present disclosure defined by the claims.

1. A radar apparatus, comprising:
a radar main body having a radiation plane; and
a housing configured to house the radar main body; wherein the housing comprises
a box-shaped component in which the radar main body is retained; and
at least one bracket protrudingly disposed on the box-shaped component and configured to be fastened to a bumper or an emblem plate;
the at least one bracket is composed of a resin material and disposed at a position offset from the center of gravity of the radar main body in a thickness direction of the radar main body;
the at least one bracket comprises
a fastening piece having an opposing surface to be opposed to the bumper or the emblem plate, the opposing surface facing the same direction as the radiation plane, wherein an insertion through hole is bored through the fastening piece, and
a rib disposed in an upright position on the fastening piece, and
the rib comprises at least one first rib extending from the box-shaped component to an end of the fastening piece in the vehicle width direction.

2. The radar apparatus according to claim 1, wherein the rib further comprises at least one second rib perpendicular to the at least one first rib.

3. The radar apparatus according to claim 2, wherein:
the at least one first rib and the at least one second rib are disposed on the opposing surface of the fastening piece;
the at least one first rib comprises a pair of first ribs, and the at least one second rib comprises a pair of second ribs; and
the pair of first ribs and the pair of second ribs constitute a guide tube.

4. A radar apparatus support structure, comprising:
the radar apparatus according to claim 3; and
the bumper or the emblem plate configured to fasten the radar apparatus, wherein the guide tube surrounds the insertion through hole, and
the bumper or the emblem plate includes an insertion cylinder configured to be inserted into the guide tube.

5. A radar apparatus support structure, comprising:
the radar apparatus according to claim 3, and
the bumper or the emblem plate configured to fasten the radar apparatus, wherein the guide tube surrounds the insertion through hole,
the bumper or the emblem plate includes a depression into which the guide tube is inserted, and
a bottom of the depression is bored by a fastening hole which is to be axially aligned with the insertion through hole.

6. The radar apparatus support structure according to claim 4, wherein:
the radar apparatus is fastened to the bumper or the emblem plate with the radiation plane arranged in a vertical position; and
the bracket comprises a plurality of brackets disposed on an upper portion of the box-shaped component.

7. The radar apparatus support structure according to claim 3, wherein
the opposing surface of the fastening piece is separated farther away from the radiation plane than a rear surface of the box shaped component is.

8. The radar apparatus support structure according to claim 5, wherein:
the radar apparatus is fastened to the bumper or the emblem plate with the radiation plane arranged in a vertical position; and
the bracket comprises a plurality of brackets disposed on an upper portion of the box-shaped component.

9. The radar apparatus support structure according to claim 4, wherein
the opposing surface of the fastening piece is separated farther away from the radiation plane than a rear surface of the box shaped component is.
